(19) United States
(12) Patent Application Publication
(10) Pub. No.: US 2016/0024701 A1
(43) Pub. Date: Jan. 28, 2016

(54) Portable Design Mat and Wall

(71) Applicant: Cheryl L. See, Ashburn, VA (US)

(72) Inventor: Cheryl L. See, Ashburn, VA (US)

(21) Appl. No.: 14/733,931

(22) Filed: Jun. 8, 2015

Related U.S. Application Data
(60) Provisional application No. 62/029,420, filed on Jul. 26, 2014.

(51) Int. Cl. D05B 97/12; F16M 13/02

(52) U.S. Cl. CPC D05B 97/12; F16M 13/02

(57) ABSTRACT

A portable design mat and wall that rolls up for travel and storage is disclosed. The design mat and wall includes a support body having a long axis, a mat attached to the support body and at least partially disposable about the support body, and a strap attached to at least one of the support body and the mat, the strap being foldable in a direction parallel to the long axis of the support body. The foldable strap may be folded to form a handle for transport and may provide support for hanging in a vertical position for display. The design mat and wall may include a marking sheet from which marks are erasable and may provide storage for sewing supplies. No hardware is required to mount the design surface so a quilt maker can use in multiple locations.

### CROSS REFERENCE TO RELATED APPLICATIONS

This application claims priority from and the benefit of provisional patent application U.S. Ser. No. 62/029,420, filed on Jul. 26, 2014, which is hereby incorporated by reference in its entirety for all purposes as if fully set forth herein.

### BACKGROUND

1. Field

This disclosure relates to devices that aid in craft construction and, more particularly, to portable devices that aid in quilt design and construction.

2. Discussion of the Background

Quilting is a fast growing and popular craft in the United States and throughout the world. Quilters spend hours creating quilts that often have complex and intricate designs and patterns, amounting to works of art. Quilters use many methods and aids to assist them in laying out these designs and patterns, which comprise many pieces of varying sizes. Some aids may be generically referred to as “design walls”. When designing a craft, such as a quilt., the artist can utilize a design wall to audition various design elements., finding the best pattern or combination of elements for use in the final product. See, e.g., Patricia Bolton, Design Wall on a Dime, Cloth Paper Scissors Studios 90 (2008).

Making quilts from small patches of fabric of different colors and prints, arranged to create pictures or patterns, is well known. Fabric samples may be cut by hand using scissors and stitched together by hand using needle and thread. In addition., quilting may be done using sewing machines, and cutting may be done with, for example, various templates, rotary cutters, and cutting mats.

The quilt design that appears on the top layer of a quilt is generally produced in one of three ways. In one type of quilting, the quilt top is made of a single fabric, and quilting stitches are sewn to form the design. In another type of quilting, the top is appliquéd, wherein pieces are cut from various cloths and stitched onto a background fabric, making a picture or pattern. In a third type of quilting, the quilt design is produced in a process called patchwork, wherein individual patches of cloth are sewn together edge to edge to form a fabric with geometric patterns. Quilt designs are often intricate and exact. A single quilt frequently involves multiple fabric colors and prints and requires hundreds of patches of cloth and numerous colors of thread to match the fabric.

Quilt makers, whether they are working with a traditional design or creating their own design, generally prepare design plans, or mock-up blocks, to see how individual fabrics work as patches in relation to each other. The quilt maker creates mock-up blocks of patches of the basic unit of the quilt construction, usually a square or a triangle, using samples of fabrics in various colors and prints. The mock-up blocks may be temporarily attached, using pins or adhesive spray, to a fabric-covered board. See, e.g. U.S. Pat. No. 6,862,823 (2002). Boards can be bulky and are not well suited for storing or transporting quilt designs. Quilters also use batting, felt, or plain white flannel on their design walls since the heavy nap of the material will hold the blocks and other components on the vertical surfaces without pinning. Quilters may also use adhesives to adhere blocks to a design wall, but such adhesives are messy, require ventilation, and provide an additional cost.

The quilt maker may use a design wall on a tabletop, frequently the family dining room table. This method has the disadvantage of inconvenience in that it requires removal of the design wall from the tabletop when there is need to use the table for other purposes. The quilt maker may also want to temporarily hang the design wall on a vertical surface so that the proposed quilt design may be viewed from a distance. Design wars often require extensive hardware for mounting, thereby making them difficult to use vertically in various or multiple locations. See, e.g., U.S. Pat. No. 20100300631 (2010), and U.S. Pat. No. 7,757,416 (2010). However, since most quilters do not have a dedicated quilting room, common rooms, such as a bedroom or dining room, are used and this new wall adornment is not a part of the room decor and must be moved frequently. Sometimes, the felt or flannel piece is nailed onto a door or doorframe. However, this is merely a short-term mounting if the door is ever to be used, as is usual, for passage in a house or apartment.

The creation of a quilt pattern can take hours or days, depending on the complexity of the pattern. The quilt maker may also want to transport the design wall with the proposed quilt design attached thereto to a quilting class, workshop, quilting bee, or guild meeting. Such exposure of the quilt design provides the quilt maker with the opportunity for others to review their quilt design as well as to stitch their quilt block together. When moving these “design walls”, whether disposed flat or horizontally on a surface or hanging vertically, great care must be taken to not disturb the blocks in the design layout already accomplished. For many years quilt makers have made their own rolling quilt block mat to carry their quilt project to these events. See, e.g., QUILTALICIOUS, Blog “Confessions of a Serial Quilter”, “Quilter's “Roll'n'go” Tutorial” (Mar. 20, 2014), Eileen Lau, Green Bird Machine Quilting website, “Quilt Block Carrier” (Circa 2007), Imrainey, The GardenWeb Home Forums, “Quilter's Roll 'N Go” (May 22, 2009) and Kathy Campbell, Fons & Porter's Love of Quilting website, “Roll-up Block Mat” (published date unknown). These quilt block carriers use ribbons to tie them closed, and such closure is not secure enough to hold the fabric pieces in transit. The pattern for the roll up carriers often recommends using fabric, fleece, felt, or flannel, which would adhere to both the cut pieces of fabric as well as to the outside of the roll when the quilt block carrier was rolled up. However, the roll up carriers are not capable of being vertically hung and, thus, were limited to use in the horizontal position, like being disposed on a surface of a table top. The bodies of the carriers may hold necessary quilting tools but are made from cardboard mailing tubes that are flimsy, are sensitive to humidity, and do not have a handle with which they may be carried. Cardboard is not acid free, and the acid can destroy fabric over time. A pattern for detachable straps could be made, but the carrier could not be used vertically or horizontally when the straps were attached. See, e.g., Christine, Bonnie, Moda Pattern, “The Roll 'N Go” (published date unknown).

Quilt makers that design quilt tops that are appliquéd will often draw out their design on a clear acrylic sheet that is placed over a design pad disposed horizontally on a surface to aid in the placement of the various pieces of fabric. See, e.g., U.S. Pat. No. 5,650,211 (1997).

Generally, the above-described devices must be assembled or constructed by the quilter. Or, the quilter must purchase a manufactured design wall or mat, which are often poorly made and still require assembly. Thus, there is a need for some type of portable quilting design wall that can cure the deficiencies as described above.

### SUMMARY

Generally, aspects of the present invention are directed to a portable design mat and wall to provide a workable surface for quilting and other crafts, a safe and secure structure for transporting the quilting and other crafts, and a simple structure for displaying the quilting and other crafts.

Aspects of the present invention provide a design mat and wall that may be hung vertically and disposed horizontally on a surface, has storage for bask quilting supplies like thread and scissors, is easy to transport with the use of a handle and can be hung for vertical use with no additional hardware. Aspects of the present invention provide a design mat and wall, which is specific for designing appliqué that has a dry erasable dear marking sheet, that is usable both vertically and horizontally, that is storage for basic quilting supplies like thread and scissors, that is easy to transport with the use of a handle and require no additional hardware to mount. Aspects of the present invention provide a design mat and wall that includes a support surface that temporarily and securely holds, without the use of pins or adhesives, a plurality of mock-up blocks for viewing and that can be opened and closed so that the mock-up blocks maintain their original positions on the device.

Aspects of the present invention provide a design mat and wall, including: a support body having a long axis, a mat attached to the support body and at least partially disposable about the support body, and a strap attached to at least one of the support body and the mat, the strap being foldable in a direction parallel to the long axis of the support body.

Aspects of the present invention provide a method for quilt design and display, the method including: disposing a piece to be quilted onto a design surface of a mat, the mat comprising the design surface, a back surface opposite the design surface, a first edge attached to a support body, folding a strap attached to at least one of the mat and the support body along a long axis of the support body, disposing the mat on which the piece is disposed about the support body and folded strap, and securing the mat in the closed position disposed about the support body.

Aspects of the present invention provide a handle to conveniently carry the design mat and wall to different locations, to provide a design mat and wall that requires no hardware for easier use in multiple locations. Aspects of the present invention provide a dear marking sheet from which markings are erasable to aid in placement of applique fabric pieces. Aspects of the present invention provide a method to dispense one or more spools of thread. Aspects of the present invention provide a place to store a small pair of scissors. These and other benefits of one or more aspects will become apparent from a consideration of the ensuing description and accompanying drawings.

Aspects of the present invention provide a support body attached to a rectangular piece of fabric with sufficient nap on one side to hold pieces of fabric to aid in quilt design and a strap attached to the support body for easy hanging for use of the design mat and wall as a vertical design wall. According to aspects of the present invention, the strap can further be used as a carrying handle to transport the object of the invention.

It is to be understood that both forgoing general descriptions and the following detailed description are exemplary and explanatory and are intended to provide further explanation of the invention as claimed. Other features, aspects, and/or advantages will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a disassembled view of a portable design mat and wall according to aspects of the present invention.

FIG. 2 illustrates a perspective view of a portable design mat and wall according to aspects of the present invention.

FIG. 3 illustrates a portable design mat and wall in a closed position according to aspects of the present invention.

FIG. 4 illustrates a disassembled view of a portable design mat and wall according to aspects of the present invention.

FIG. 5 illustrates a perspective view of a portable design mat and wall according to aspects of the present invention.

FIG. 6 illustrates a portable design mat and wall in a closed position according to aspects of the present invention.

FIG. 7 illustrates a disassembled view of a portable design mat and wall with the appliqué design sheet according to aspects of the present invention.

FIG. 8 illustrates a perspective view of a portable design mat and wall with the appliqué design sheet according to aspects of the present invention.

FIG. 9 illustrates a perspective view of a portable design mat and wall in a hanging position with the clear marking sheet flipped over the support body to the back surface of the mat according to aspects of the present invention.

### DETAILED DESCRIPTION

Hereinafter, exemplary embodiments of the present invention will be described with reference to the accompanying drawings. In the following description and drawings, the same reference numerals are used to designate the same or similar components, and so repetition of the description on the same or similar components may be omitted. In the following description, a detailed description of known functions and configurations incorporated herein will be omitted when it may make the subject matter of the present invention rather unclear.

Further, in the following description, elements of the present invention may be named by using terms, such as the first, the second, A, B, (a), and (b). However, such terms are used only to discriminate those elements from other elements and do not limit the essence, sequence, or order of the elements. If it is read that one element is “connected”, “combined”, or “attached” to another element, it should be understood that not only may the element be directly connected, combined, or attached to the other element but a third element may also be connected, combined, or attached between the element and the other element.

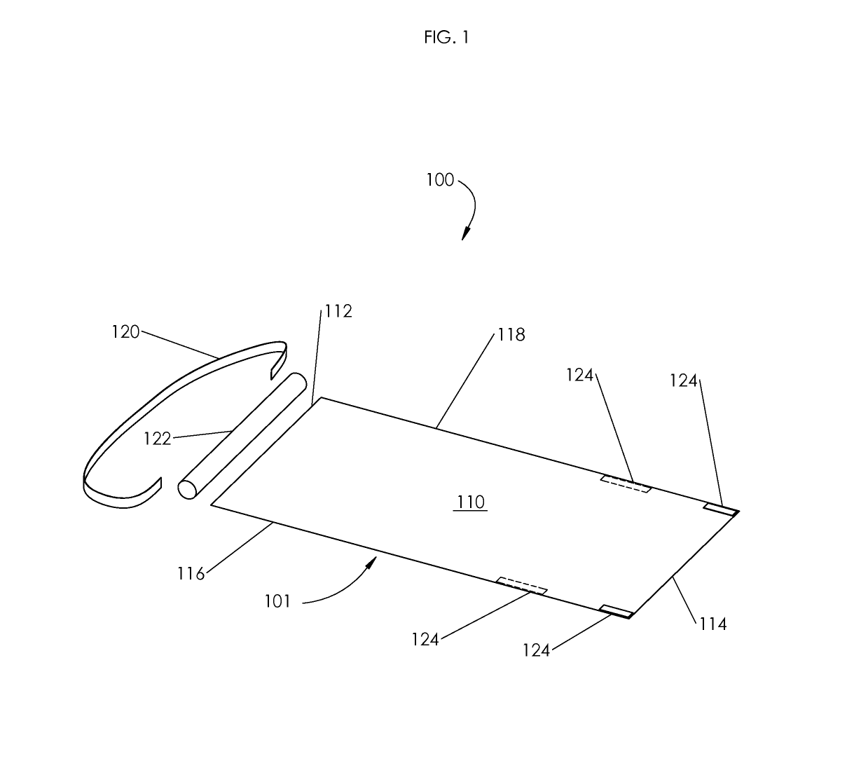

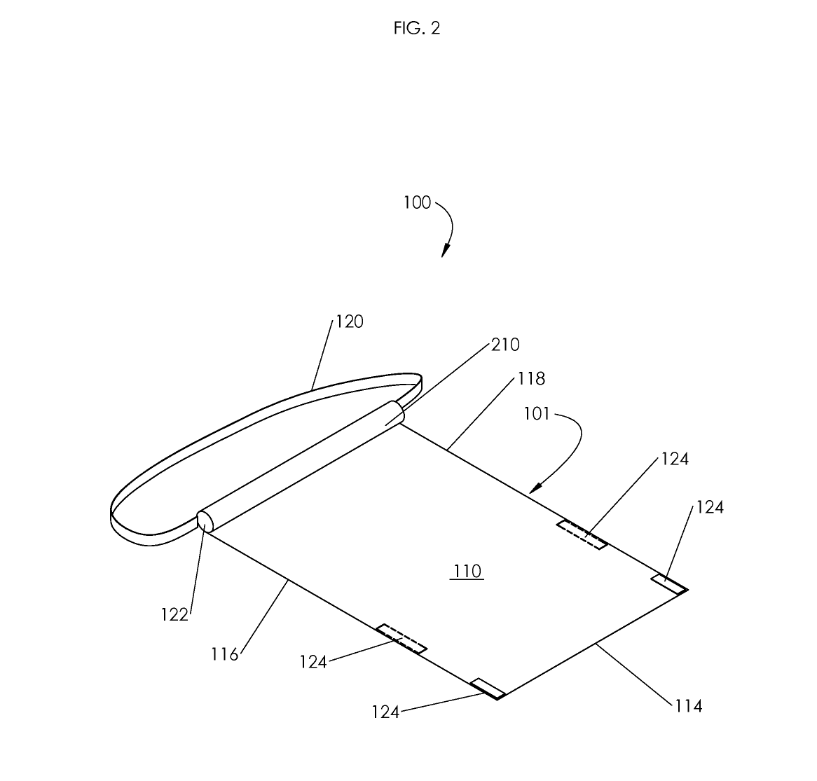

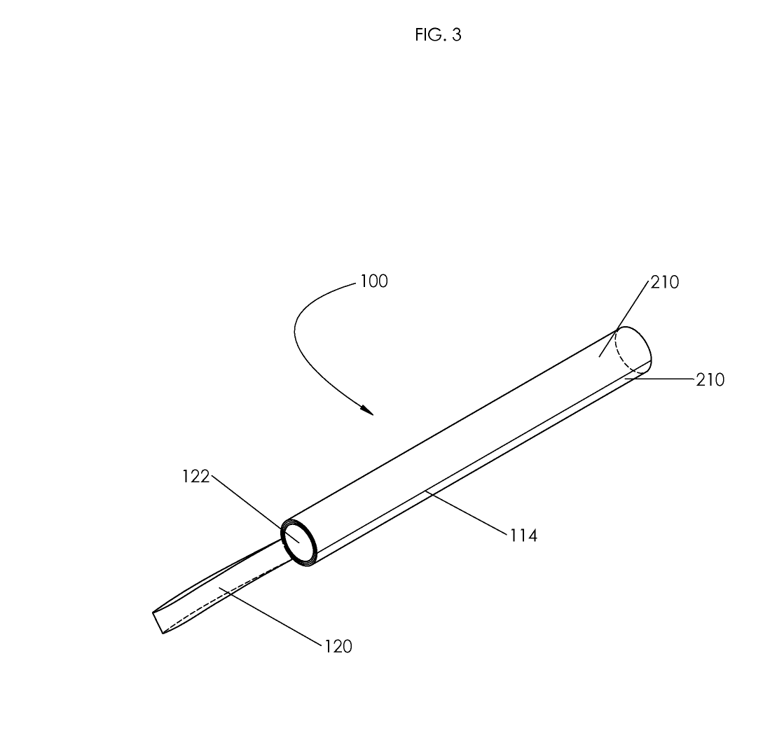

FIG. 1 illustrates a disassembled view of a portable design mat and wall according to aspects of the present invention. FIG. 2 illustrates a perspective view of a portable design mat and wall according to aspects of the present invention. FIG. 3 illustrates a portable design mat and wall in a closed position according to aspects of the present invention.

A portable design mat and wall 100, as shown disassembled in FIG. 1, includes a mat 101, a support body 122, and a strap 120. The mat 101 has a design surface 110, a first edge 112, a second edge 114, a first side edge 116, a second side edge 118, and a back surface 210. The back surface 210 is opposite the design surface 110 and is visible in FIGS. 2 and 3 when at least a portion of the mat 101 is rolled, folded, or disposed about a surface of the support body 122. The first and second edges 112, 114 of the mat 101 are each straight and are disposed parallel to each other. The first and second side edges 116, 118 of the mat 101 are each straight and are disposed parallel to each other and perpendicular to the first and second edges 112, 114. In general, the mat 101 may be of a rectangular shape. The first and second edges 112, 114 of the mat 101 may be, for example, 6 to 48 inches, and the first and second side edges 116, 118 of the mat 101 may be, for example, 24 to 60 inches; however, aspects need not be limited thereto.

The mat 101 may be made of a vinyl having a sufficient texture on one side of the vinyl suitable for the design surface 110 and a smooth surface on a second side of the vinyl suitable for the back surface 210 of the mat 101, but other materials are also suitable. Further, although shown as a single element, the mat 101 may include multiple layers of material attached or bonded together to provide the different properties of each of the design surface 110 and the back surface 210. For example, the mat 101 may include one or more of vinyl, flannel, fleece, leather, suede, felt, or the like.

The strap 120 may be an appropriate length for carrying and/or displaying the design mat and wall 100. The strap 120 may be attached to the mat 101 at the design surface 110 or the back surface 210 adjacent to or near the first and second side edges 116, 118, respectively, and adjacent to or near the first edge 112 of the mat 101. However, aspects need not be limited thereto such that the strap 120 may be attached to the support body 122. For example, ends of the strap 120 may be attached to ends of the support body 122, respectively, or at least one of the ends of the strap 120 may be attached to a side surface of the support body 122 about which the mat 101 is disposed when the design mat and wall 100 is disposed in the closed position as shown in FIG. 3. Moreover, the support body 122 could be hollow with open ends, and at least one end of the strap 120 may be attached to an internal surface of the support body 122. The strap 120 may be attached to the support body 122 at a portion of the support body 122 opposite from a portion of the support body 122 to which the mat 101 is attached, i.e., the strap 120 and the mat 101 may be attached to opposite sides of the support body 122. However, aspects need not be limited thereto; for example, the strap 120 and the mat 101 may be attached to the support body 122 at a same portion of the support body 122, may be attached adjacently to the support body 122, or may be attached to a side or portion of the support body 122, for example, a quarter of the way around the support body 122. The strap 120 may be foldable to be disposed between the mat 101 and the support body 122 when the design mat and wall 100 is disposed in the closed position as shown in FIG. 3. The foldability of the strap 120 provides for the design mat and wall 100 to be easily disposed in the closed position as shown in FIG. 3. Specifically, the foldability of the strap 120 allows for the mat 101 to be rolled or wrapped around the strap 120 and the support body 122 instead of between the strap 120 and the support body 122. Further, the strap 120 may include a fastener to secure the strap 120 to the mat 101 and/or the support body 122 when the design mat and wall 100 is disposed in the closed position as shown in FIG. 3.

Further, the strap 120 may be attached to both the mat 101 and the support body 122. For example, the strap 120 may be sewn, glued, or otherwise attached to the mat 101 and/or the support body 122. Additionally or separately, the strap 120, the mat 101, and the support body 122 may be stapled. The strap 120, the mat 101, and the support body 122 may be arranged such that the strap 120 is disposed between the mat 101 and the support body 122, the mat 101 is disposed between the strap 120 and the support body 122, or the support body 122 is disposed between the strap 120 and the mat 101.

The strap 120 may be made of ribbon, but other materials are also suitable. For example, the strap 120 may be made of ribbon, fabric, chain, plastic, nylon, rope, canvas, cord, leather, suede, felt, or the like. The strap 120 may have an appropriate length and may be, for example, 8 inches to 18 inches longer than a length of the support body 122, but other lengths are also suitable. The strap 120 may be attached to the support body 122 according to any appropriate fastener, for example, staples, glue, nails, an adhesive, rivets, buttons, or the like, but other materials and methods of attachment may also be suitable.

The first edge 112 of the mat 101 is attached to an outside of the support body 122. The first edge 112 of the mat 101 may be attached to the support body 122 such that the design surface 110 is disposed adjacent to the support body 122 and the back surface 210 of the mat 101 is disposed away from the support body 122. The first edge 112 may be attached or connected to the support body 122 along a direction parallel to a long axis of the support body 122.

The support body 122 may be made from plastic, wood, metal, or the like. A length of the support body 122 may be at least 12 inches long, but other lengths are also suitable. For example, the length of the support body 122 along a long axis of the support body 122 may be 2 feet or 3 feet or longer, or may be fewer than 12 inches long, for example, 6, 8, 10, 11 inches, or the like. The support body 122 may have a cylinder shape as shown in FIGS. 1 to 3, and may have a diameter of at least 1 inch, but other diameters are also suitable. For example, the support body 122 may have a cylinder shape with a diameter of 2, 3, 5, or more inches. However, aspects of the present invention need not be limited thereto such that the support body 122 may have a polygonal prism shape of similar dimensions, for example, a triangular prism shape, a square or rectangular prism shape, a pentagonal prism shape, or the like. The mat 101 may be stapled to the support body 122 with staples and an air compressor, but other materials are also suitable. For example, the mat 101 may be attached to the support body 122 by staples, glue, nails, hook and loop, snaps, grommets, ties, ribbon, fabric, adhesive, rivets, buttons, or the like. FIG. 2 shows the design surface 110 of the mat 101 attached to the support body 122 according to aspects of the present invention, but aspects need not be limited thereto. For example, a hole or slot may be provided in a surface of the support body 122 such that the mat 101 may be attached to an internal surface of the support body 122 and extend through the hole or slot to allow the design surface 110 to be a workable surface on which patterns of patches or units of fabric may be disposed or displayed. Further, the mat 101 may be attached to the support body 122 permanently or semipermanently such that the mat 101 may be detachable from the support body 122.

Hook and loop or cooperable fasteners 124 are attached to the design surface 110 and the back surface 210 of the mat 101 along the first and second side edges 116, 118, respectively, of the mat 101 near the second edge 114 of the mat 101. The fasteners 124 may be hook and loop, buttons, reusable adhesives, snaps, grommets, ties, ribbon, or fabric or any other suitable fastener. The fasteners 124 disposed on the design surface 110 of the mat 101 are disposed adjacent to the second edge 114 of the mat 101 and adjacent to the first and second side edges 116, 118, respectively, of the mat 101. The fasteners 124 disposed on the back surface 210 of the mat 101 are disposed adjacent to the first and second side edges 116, 118, respectively, of the mat 101 but are spaced from the second edge 114 of the mat 101 so as to accommodate the thickness of the mat 101, a diameter or thickness of the support body 122, and various thicknesses of the fabric pieces that will be disposed and stored on the design surface 110 when the mat 101 is rolled, folded, or disposed about the support body 122 in the closed position as shown in FIG. 3. For example, centers of the fasteners 124 may be spaced apart by a distance between about equal to a circumferential length of the support body 122 to about four times the circumferential length of the support body 122. The fasteners 124 disposed on the design surface 110 of the mat 101 appropriately correspond to the fasteners 124 disposed on the back surface 210 so as to secure the design mat and wall 100 in the closed position as shown in FIG. 3. For example, centers of the fasteners 124 may be spaced apart by 6 to 10 inches but aspects need not be limited thereto, for example, the fasteners may be spaced apart by 10 or more inches. Further, although the fasteners 124 are shown as being disposed in a direction parallel to the first and second side edges 116, 118, aspects need not be limited thereto such that one or more fasteners 124 may be disposed on the design surface 110 along the second edge 114 of the mat 101 and one or more fasteners 124 may be disposed on the back surface 210 to correspond to the one or more fasteners 124 disposed on the design surface 110 when the design mat and wall 100 is disposed in the closed position as shown in FIG. 3.

A perspective view of the design mat and wall 100 is shown in FIG. 2 as the quilt maker would use it disposed on a surface in a horizontal position. From the closed position shown in FIG. 3, a quilt maker will unfasten the fasteners 124 and unroll the design mat and wall 100 to the open position shown in FIG. 2. The design mat and wall 100 may be disposed on a flat surface to use the design mat and wall 100 in the horizontal position as a design mat or to expose a stored pattern disposed on the design surface 110 of the mat 101. The design mat and wall 100 may be referred to as a combined design mat and design wall. The quilt maker then creates or manipulates mock-up blocks of the basic unit of the quilt construction using samples of fabrics in various colors and prints, placing the mock up blocks directly on the design surface 110 of the mat 101. The texture or nap of the design surface 110 allows the fabric pieces to adhere to the design surface 110. The samples of fabrics disposed on the design surface 110 of the mat 101 can be removed and repositioned on the design surface 110 of the mat 101 until the quilt maker is satisfied with the block.

The quilt maker can hang the design mat and wall 100 on a stand, a hook, a wall, a door frame, a door knob, or the like, by the strap 120 such that the design mat and wall 100 may be disposed in a vertical position as a design wall. When the design mat and wall 100 is disposed in the vertical position as a design wall, the mat 101 may be disposed at least partially about the support body 122. Hanging the design mat and wall 100 in the vertical position allows the quilt maker to view the mock-up blocks from a distance to determine if any changes need to be made to the design. While the design mat and wall 100 is disposed in the vertical position, fabric pieces can be removed and repositioned until the quilt maker is satisfied with the block. The quilt maker can keep the design mat and wall 100 hanging in the vertical position as a design wall while she works on other blocks, or the design mat and wall 100 can be removed from the wall and disposed in a horizontal position on a surface, for example, a table, such that the quilt block can be worked on. The quilt maker can stop working on the block at any time. The design mat and wall 100 can be closed from the open position shown in FIG. 2 by folding the strap 120 towards one of the first and second edges 116, 118 of the mat 101 to be flush and parallel to the length of the support body 122 to form a loop that protrudes past one of the ends of the support body 122. The design mat and wall 100 can be rolled up and secured with the fasteners 124. The design mat and wall 100 can be rolled up by disposing the mat 101 about at least a portion of the strap 120 and the support body 122 so that the design surface 110 of the mat 101 is adjacent, at least initially, to the support body 122 to secure any quilt blocks disposed on the design surface 110 between the design surface 110 of the mat 101 and the support body 122 or between the design surface 110 of the mat 101 and the back surface 210 of the mat 101 when the mat 101 has been rolled over the surface of the support body 122 onto the back surface 210 of the mat 101.

The portion of the strap 120 exposed at one of the ends of the support body 122 can support the design mat and wall 100 for carrying as a handle that was formed by the loop in the strap 120 like one would carry an umbrella. FIG. 3 shows the design mat and wall 100 in the closed position with the strap 120 folded to form the handle.

The back surface 210 may be smooth such that the fabric pieces will not adhere to the smooth surface of the back surface 210 of the mat 101 and such that the fabric pieces remain and are secured in the intended positions on the design surface 110 of the mat 101 while the design mat and wall 100 is transported or stored. When in the closed position as shown in FIG. 3, the fasteners 124 disposed on the design surface 110 come in contact with the fasteners 124 disposed on the back surface 210 to securely hold the mat 101 in place about the support body 122. The securing of the fasteners 124 contributes to the holding of the samples or patterns to remain where intended. The fasteners 124 are spaced to accommodate the thickness of the mat 101, the thickness of the support body 122, and varying thicknesses of the fabric pieces that will be disposed and stored on the design surface 110 when the mat 101 is rolled, folded, or disposed about the support body 122 in the closed position as shown in FIG. 3. The secure closing of the design mat and wall 100 allows the quilt maker to easily move the blocks in progress from one location to another location, such as a quilt guild meeting, bee or workshop. The handle that is formed from the strap 120 can be slid over the quilt maker's arm or shoulder freeing both of the quilt maker's hands to hold other items during transit.

The dual-purpose strap 120 allows the design mat and wall 100 to be hung vertically as a quilt design wall and used horizontally as a design mat. When the design mat and wall 100 is hung vertically from the strap 120, the support body 122 supports an entire width of the mat 101 along the first edge 112. When rolled up the strap 120 becomes a useful handle to carry the design mat and wall 100 like an umbrella as the strap 120 may be folded along the long axis of the support body 122 to extend beyond an end of the support body 122. The dual-purpose strap 120 of the design mat and wall 100 eliminates the need for additional mounting hardware in multiple locations. The quilt maker does not need any special tools or any additional time, expertise, or money to hang the design mat and wall 100. The quilt maker does not have to commit to having a design surface 110 in one location only. The design mat and wall 100 is a sturdy method to transport a quilt project from one location to the next. The design mat and wall 100 is compact enough to store easily if the quilt maker needs to work on a different project and needs to quickly set the current project aside.

As shown in FIG. 3, when the design mat and wall 100 is disposed in the closed position, the mat 101 is rolled about the support body 122 such that the design surface 110 is disposed toward the support body 122 and the back surface 210 is exposed. The arrangement of the closed position of the design mat and wall 100 protects the blocks in progress of the quilt from external elements and influence so as to allow for safe movement and transport of the design. Further, the strap 120 is foldable and folded under the mat 101 such that a portion of the strap 120 extends beyond an end of the support body 122 to form a handle for carrying and transporting the design mat and wall 100.

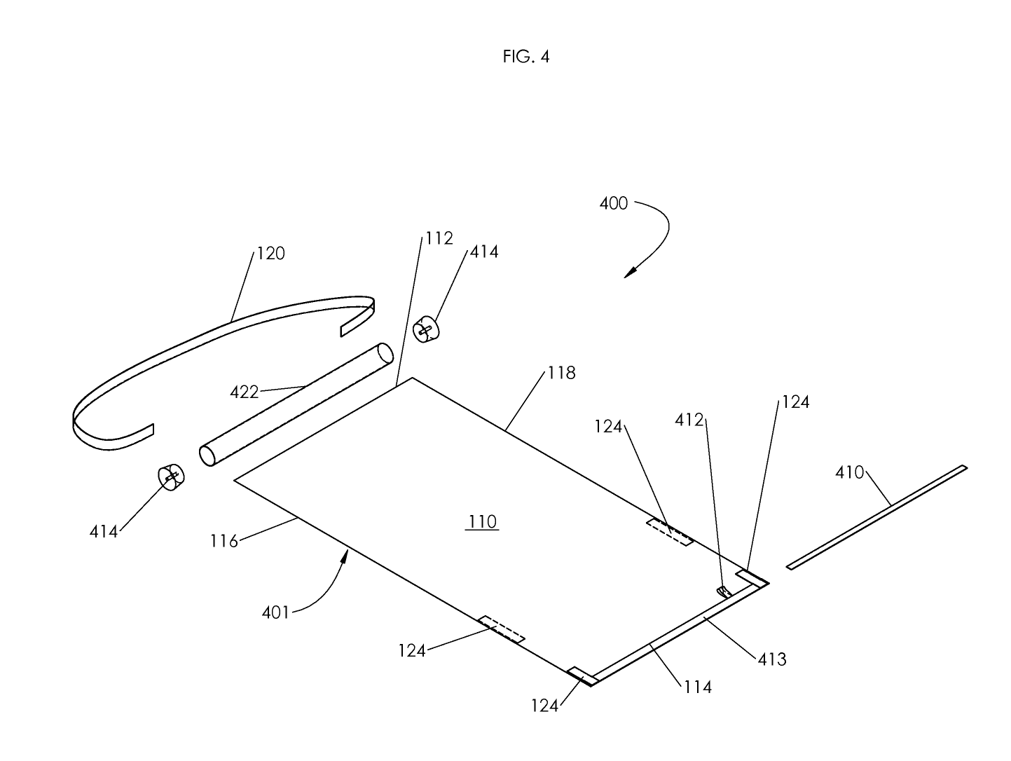

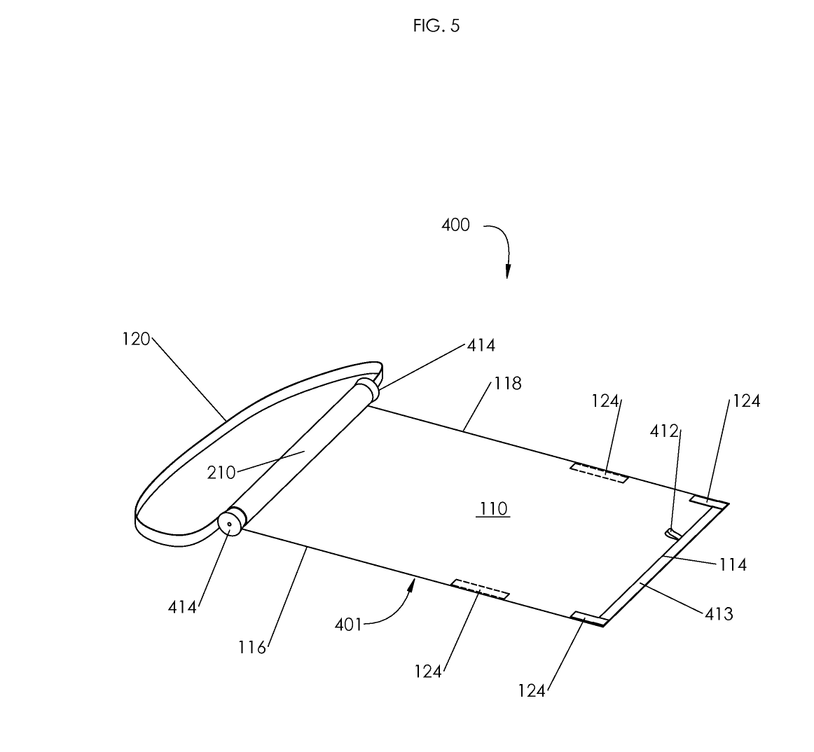

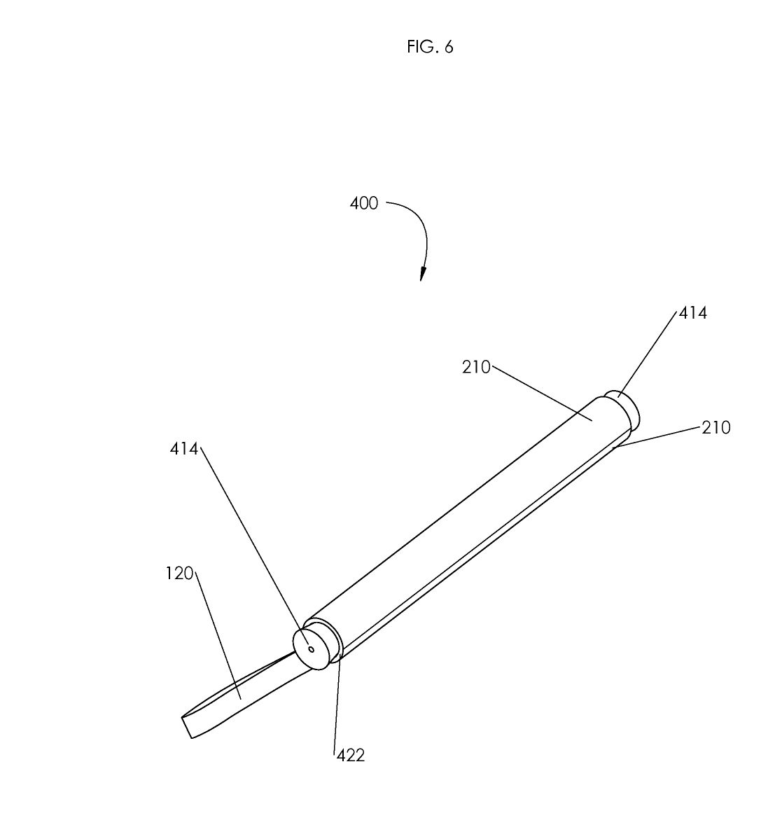

FIG. 4 illustrates a disassembled view of a portable design mat and wall according to aspects of the present invention. FIG. 5 illustrates a perspective view of a portable design mat and wall according to aspects of the present invention. FIG. 6 illustrates a portable design mat and wall in a closed position according to aspects of the present invention.

A portable design mat and wall 400, as shown disassembled in FIG. 4, includes a mat 401, a support body 422, and a strap 120. The mat 401 has a design surface 110, a first edge 112, a second edge 114, a first side edge 116, a second side edge 118, and a back surface 210. The back surface 210 is opposite the design surface 110 and is visible in FIGS. 5 and 6 when at least a portion of the mat 401 is rolled, folded, or disposed about a surface of the support body 422. The first and second edges 112, 114 of the mat 401 are each straight and are disposed parallel to each other. The first and second side edges 116, 118 of the mat 401 are each straight and are disposed parallel to each other and perpendicular to the first and second edges 112, 114. In general, the mat 401 may be of a rectangular shape. The first and second edges 112, 114 of the mat 401 may be, for example, 6 to 48 inches, and the first and second side edges 116, 118 of the mat 401 may be, for example, 24 to 60 inches; however, aspects need not be limited thereto.

The strap 120 may be made of ribbon, but other materials are also suitable. For example, the strap 120 may be made of ribbon, fabric, chain, plastic, nylon, rope, canvas, cord, leather, suede, felt, or the like. The strap 120 may be attached to the mat 401 near the first edge 112 of the mat 401. The first edge 112 of the mat 401 may be attached to the support body 422. However, aspects need not be limited thereto such that the strap 120 may be attached to the support body 422. For example, ends of the strap 120 may be attached to ends of the support body 422, respectively, or at least one of the ends of the strap 120 may be attached to a side surface of the support body 422 about which the mat 401 is disposed when the design mat and wall 400 is disposed in the closed position as shown in FIG. 6. Moreover, the support body 422 could be hollow with open ends, and at least one end of the strap may be attached to an internal surface of the support body 422. The strap 120 may be attached to the support body 422 at a portion of the support body 422 opposite from a portion of the support body 422 to which the mat 401 is attached, i.e., the strap 120 and the mat 401 may be attached to opposite sides of the support body 422. However, aspects need not be limited thereto; for example, the strap 120 and the mat 401 may be attached to the support body 422 at a same portion of the support body 422, may be attached adjacently to the support body 422, or may be attached to a side or portion of the support body 422, for example, a quarter of the way around the support body 422. The strap 120 may be foldable to be disposed between the mat 401 and the support body 422 when the design mat and wall 400 is disposed in the closed position as shown in FIG. 6. The foldability of the strap 120 provides for the design mat and wall 400 to be easily disposed in the closed position as shown in FIG. 6. Specifically, the foldability of the strap 120 allows for the mat 401 to be rolled or wrapped around the strap 120 and the support body 422 instead of between the strap 120 and the support body 422. Further, the strap 120 may include a fastener to secure the strap 120 to the mat 401 and/or the support body 422 when the design mat and wall 400 is disposed in the closed position as shown in FIG. 6.

Further, the strap 120 may be attached to both the mat 401 and the support body 422. For example, the strap 120 may be sewn, glued, or otherwise attached to the mat 401 and/or the support body 422. Additionally or separately, the strap 120, the mat 401, and the support body 422 may be stapled. The strap 120, the mat 401, and the support body 422 may be arranged such that the strap 120 is disposed between the mat 401 and the support body 422, the mat 401 is disposed between the strap 120 and the support body 422, or the support body 422 is disposed between the strap 120 and the mat 401.

The support body 422 may be a hollow cylinder or a hollow polygonal prism. The support body 422 may be made of polyvinyl chloride (PVC) pipe, but other materials are also suitable. For example, the support body 422 may be made from a polymer, a plastic, a metal, wood, or the like. A length of the support body 422 may be at least 12 inches long, but other lengths are also suitable. For example, the length of the support body 422 along a long axis of the support body 422 may be 2 feet or 3 feet or longer, or may be fewer than 12 inches long, for example, 6, 8, 10, 11 inches, or the like. The support body 422 may have a hollow cylinder shape as shown in FIGS. 4 to 6, and may have a diameter of at least 1 inch, but other diameters are also suitable. For example, the support body 422 may have a cylinder shape with a diameter of 2, 3, 5, or more inches. The diameter may be an internal diameter or an external diameter. However, aspects of the present invention need not be limited thereto such that the support body 422 may have a hollow polygonal prism shape of similar dimensions, for example, a triangular prism shape, a square or rectangular prism shape, a pentagonal prism shape, or the like. The width of the support body 422 may be a distance perpendicular to a long axis of the support body 422. The mat 401 may be attached to the support body 422 at the first edge 112 of the mat 401 with staples and an air compressor, but other materials are also suitable. For example, the mat 401 may be attached to the support body 422 by staples, glue, nails, hook and loop, snaps, grommets, ties, ribbon, fabric, adhesive, rivets, buttons, or the like.

The design mat and wall 400 may further include end caps 414 disposable to close ends of the support body 422. The end caps 414 may be eliminated from, attached permanently to, or attached removably to the support body 422. The end caps 414 are attachable to each end of the support body 422 to create a storage container for accessories, for example, sewing supplies, such as thread, needles, pins, or the like, to be storable in the hollow support body 422. The end caps 414 may be solid or have one or more holes or slots extending therethrough. The end caps 414 be made of tapered rubber stoppers with center holes, but other materials are also suitable. For example, the end caps 414 may be made of rubber, silicone, wood, plastic, acrylic, cork, or the like. The end caps 414 may be secured in the ends of the support body 422 by friction, reusable adhesives, or the like. Further, the end caps 414 may include threads disposed about a surface of the end caps 414 threadable into complementary threads disposed on or in the ends of the support body 422. Moreover, the end caps 414 and the ends of the support body 422 may include complementary locking mechanisms such as pins and slots or a safety lock cap. The end caps 414 may be tapered, inset, or attached over the end of the support body 422 and/or the mat 401 wrapped around the support body 422. Further, the end caps 414 may include, incorporate, or be pincushions to hold pins and the like disposed therein.

A second edge 114 of the mat 401 is reinforced with a support strip 413 and/or a batten 410. The support strip 413 may be a folded portion of the mat 401. For example, the support strip 413 may be a portion of the second edge 114 of the mat 401 folded towards the design surface 110 and toward the first edge 112 and support body 422 such that the back surface 210 of the design surface 110 is exposed. The second edge 114 of the mat 401 may be sewn to the design surface 110 of the mat 401 to form the support strip 413. The support strip 413 may also be sewn along the first and second side edges 116, 118. Further, the batten 410 may be inserted into the support strip 413 before or after the second edge 114 is sewn and/or before or after at least one of the first and second side edges 116, 118 is sewn. However, aspects need not be limited thereto such that the batten 410 may be adhered and/or attached to the mat 401 separately from and without the support strip 413. The batten 410 may be made of a metal, wood, or plastic, for example, a curved metal surface similar to a measuring tape or slap bracelet shape, but other materials are also suitable. For example, the batten 410 may be made of cardboard or upholstery tape. The batten 410 stabilizes the second edge 114 of the mat 401 and prevents quilt pieces from slipping out of the design mat and wall 400.

A loop 412 is attached to the second edge 114 of the design surface 110. The loop 412 be made of a fabric, plastic, canvas, leather, suede, felt, ribbon, or the like, and other materials are also suitable. The loop 412 may be inserted or attached to the mat 401 before sewing the second edge 114 to form the support strip 413 so that the loop 412 may be secured to the mat 401 by the support strip 413. The loop 412 may be used to securely hold accessories in the mat 401 when the design mat and wall 400 is disposed in the closed position as shown in FIG. 6. Although only one loop 412 is shown, aspects need not be limited thereto such that plural loops may be provided, and such loops may be of different sizes and may be detachable.

Hook and loop or cooperable fasteners 124 are attached to the design surface 110 and the back surface 210 of the mat 401 along the first and second side edges 116, 118, respectively, of the mat 401 near the second edge 114 of the mat 401. The fasteners 124 may be hook and loop, buttons, reusable adhesives, snaps, grommets, ties, ribbon, or fabric or any other suitable fastener. The fasteners 124 disposed on the design surface 110 of the mat 401 are disposed adjacent to the second edge 114 of the mat 401 and adjacent to the first and second side edges 116, 118, respectively, of the mat 401. The fasteners 124 disposed on the back surface 210 of the mat 401 are disposed adjacent to the first and second side edges 116, 118, respectively, of the mat 401 but are spaced from the second edge 114 of the mat 401 so as to accommodate the thickness of the mat 401, a diameter or thickness of the support body 422, and various thicknesses of the fabric pieces that will be disposed and stored on the design surface 110 when the mat 401 is rolled, folded, or disposed about the support body 422 in the closed position as shown in FIG. 6. For example, centers of the fasteners 124 may be spaced apart by a distance between about equal to a circumferential length of the support body 422 to about four times the circumferential length of the support body 422. The fasteners 124 disposed on the design surface 110 of the mat 401 appropriately correspond to the fasteners 124 disposed on the back surface 210 so as to secure the design mat and wall 400 in the closed position as shown in FIG. 6. For example, centers of the fasteners 124 may be spaced apart by 6 to 10 inches but aspects need not be limited thereto, for example, the fasteners may be spaced apart by 10 or more inches. Further, although the fasteners 124 are shown as being disposed in a direction parallel to the first and second side edges 116, 118, aspects need not be limited thereto such that one or more fasteners 124 may be disposed on the design surface 110 along the second edge 114 of the mat 401 and one or more fasteners 124 may be disposed on the back surface 210 to correspond to the one or more fasteners 124 disposed on the design surface 110 when the design mat and wall 400 is disposed in the closed position as shown in FIG. 6.

A perspective view of the design mat and wall 400 is shown in FIG. 5 as it would be used by a quilt maker as disposed on a horizontal surface. The design mat and wall 400 as disposed in the closed position is shown in FIG. 6.

The support body 422 is of sufficient diameter to accommodate basic sewing supplies and accessories, like multiple spools of thread, needles, pins, scissors, a seam ripper, thimble, and the like, disposed therein. The end caps 414 placed at each end of the support body 422 ensures that sewing supplies will not be lost in travel and will be conveniently ready whenever the quilt maker is ready to work on the block. The holes or slots in the end caps 414 allow the thread that is stored in the support body 422 to be dispensed through the hole or slot for use in the construction of the quilt block. Further, the holes or slots may be provided in the support body 422 so as to dispense thread therethrough. Spools of thread can often fall onto the floor when thread is being dispensed causing them to unravel, get dirty, or become lost. A quilt maker may need multiple colors of thread to match the many colors of fabric pieces used in the block. The support body 422, according to aspects of the invention, provides sufficient internal space in which multiple spools of thread are easily storable. The loop 412 at the second edge 114 of the mat 401 may also be used to hold quilting and sewing supplies and accessories. For example, a pair of scissors can be stored in the design mat and wall 400 by placing one of the handles of the pair of scissors into the loop 412 at the second edge 114 of the mat 401 and closing the handles of the scissors to secure the scissors in the loop 412. Needles and pins can be stored by placing the ends under the fasteners 124 along the first and second side edges 116, 118 respectively, near the second edge 114 of the design surface 110. Further, additional pads may be disposed on the design surface 110 of the mat 401 to accept needles and pins. The batten 410 disposed in the support strip 413 at the second edge 114 of the mat 401 reinforces and secures the design mat and wall 400 to further ensure that fabric pieces will not slip off of the design surface 110 and be lost during transport. The design mat and wall 400 is shown in FIG. 6 in the closed position.

The strap 120 allows the design mat and wall 400 to be hung vertically as a quilt design wall and used horizontally as a design mat. When rolled up the strap 120 becomes a useful handle to carry the design mat and wall 400 like an umbrella as the strap 120 may be folded along the long axis of the support body 122 to extend beyond an end of the support body 422. The strap 120 of the design mat and wall 400 eliminates the need for additional mounting hardware when used in multiple locations. The quilt maker does not need any special tools or any additional time, expertise, or money to hang the design mat and wall 400. The quilt maker does not have to commit to having a design surface 110 in one location only. This design mat and wall 400 is a sturdy method to transport a quilt project from one location to the next. Quilt makers will have all of the sewing tools that they need to work on their project ready to go. Sewing thread is easily stored, dispensed, and protected from unraveling or becoming lost. The storage space in the support body 422 is generous enough to accommodate multiple spools of thread that are necessary to work with multiple colors of fabric. The design mat and wall 400 is compact enough to store easily if the quilt maker needs to work on a different project and needs to quickly set the current project aside. The handle that is formed from the strap 120 can be slid over the quilt maker's arm or shoulder freeing both of the quilt maker's hands to hold other items during transit.

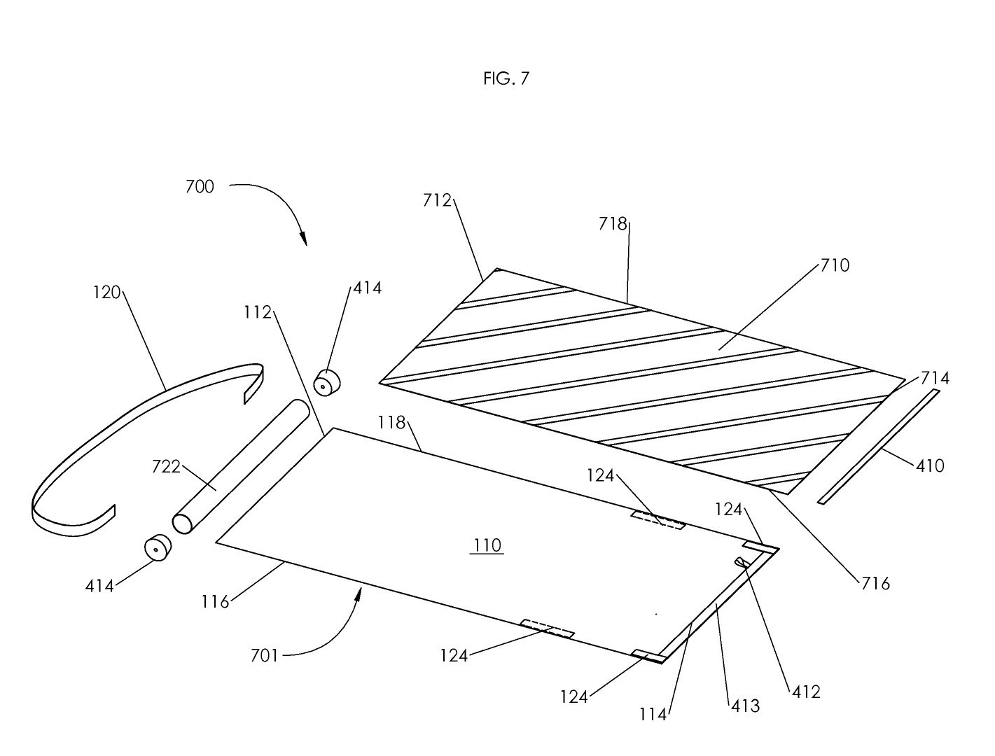

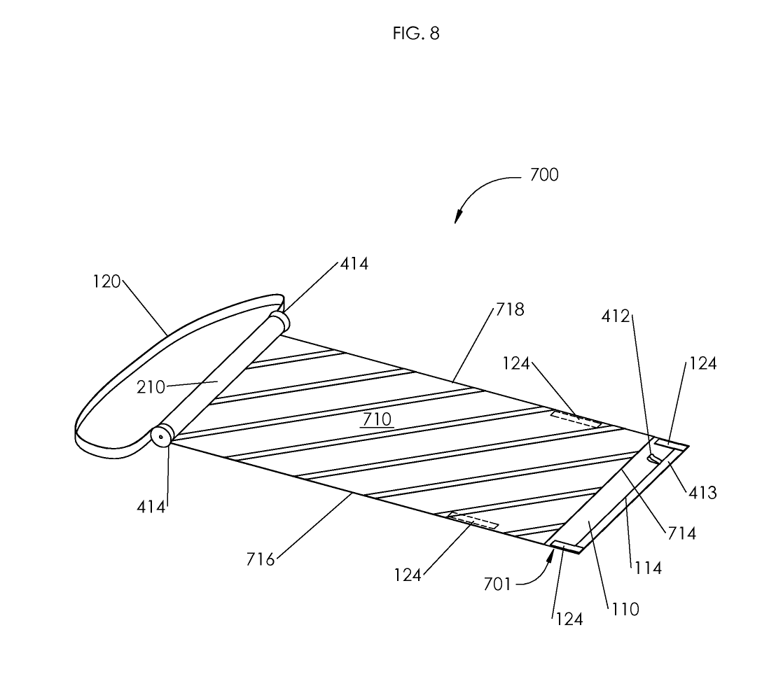

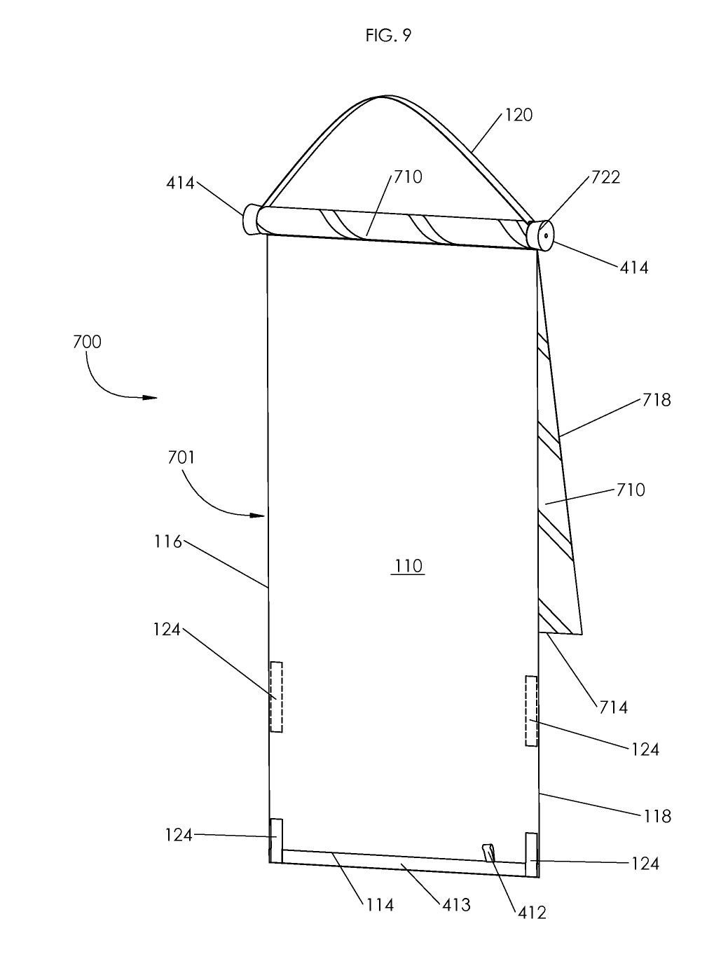

FIG. 7 illustrates a disassembled view of a portable design mat and wall with a marking sheet according to aspects of the present invention. FIG. 8 illustrates a perspective view of a portable design mat and wall with the marking sheet according to aspects of the present invention. FIG. 9 illustrates a perspective view of a portable design mat and wall disposed in a hanging position with the marking sheet flipped over the support body to the back surface of the mat according to aspects of the present invention.

A portable design mat and wall 700, as shown disassembled in FIG. 7, includes a mat 701, a marking sheet 710, a support body 722, and a strap 120. The mat 701 has a design surface 110, a first edge 112, a second edge 114, a first side edge 116, a second side edge 118, and a back surface 210. The marking sheet 710 of the mat 701 has a first edge 712 and a second edge 714, a first side edge 716, and a second side edge 718. The back surface 210 is opposite the design surface 110 and is visible in FIG. 8 when at least a portion of the mat 701 is rolled, folded, or disposed about a surface of the support body 722. The first and second edges 112, 114 of the mat 701 are each straight and are disposed parallel to each other. The first and second side edges 116, 118 of the mat 701 are each straight and are disposed parallel to each other and perpendicular to the first and second edges 112, 114. Similarly, the first and second edges 712, 714 of the marking sheet 710 are each straight and are disposed parallel to each other. The first and second side edges 716, 718 of the marking sheet 710 are each straight and are disposed parallel to each other and perpendicular to the first and second edges 712, 714.

In general, the mat 701 and the marking sheet 710 may be of rectangular shapes. The first and second edges 112, 114 of the mat 701 may be, for example, 6 to 48 inches in length, and the first and second side edges 116, 118 of the mat 701 may be, for example, 24 to 60 inches in length; however, aspects need not be limited thereto. Further, the first and second edges 712, 714 of the marking sheet 710 may be of a similar length to the first and second edges 112, 114 of the mat 701 and may be, for example, 6 to 48 inches in length. The first and second side edges 716, 718 of the marking sheet 710 may be of a lesser length than the first and second side edges 116, 118 of the mat 701 so as to expose the fasteners 124 disposed on the design surface 110 of the mat 701 for attachment to the fasteners 124 disposed on the back surface 210 of the mat 701 when the design mat and wall 700 is disposed in a closed position similar to as shown in FIGS. 3 and 6. For example, the first and second side edges 716, 718 of the marking sheet 710 may be 2 to 10 inches shorter than the lengths of the first and second side edges 116, 118 but aspects need not be limited thereto.

The marking sheet 710 may be attached or connected to the design surface 110 of the mat 701, may be attached simultaneously with the mat 701 to the support body 722, or may be attached separately from but in a similar fashion to the mat 701 to the support body 722. The marking sheet 710 may be connected to the design surface 110 of the mat 701 along one or more edges of the marking sheet 710 such that patterns and patches may be disposed between the design surface 110 and the marking sheet 710. The marking sheet 710 may be attached to the mat 701 with, for example, staples, or may be detachably attached to the mat 701 with, for example, hook and loop fasteners. When the design mat and wall 700 is rolled, folded, or disposed in the closed position similar to as shown in FIGS. 3 and 6, the marking sheet 710 is disposed closer to the support body 722 than the mat 701 such that the back surface 210 of the mat 701 is exposed externally and patterns and patches disposed on the design surface 110 of the mat 701 between the marking sheet 710 and the mat 701 are protected and held securely in place. The design mat and wall 700 may include more than one marking sheet 710 such that complex designs may be broken down across plural marking sheets 710.

Further, the strap 120 may be attached to both the mat 701 and the support body 722. For example, the strap 120 may be sewn, glued, or otherwise attached to the mat 701 and/or the support body 722. Additionally or separately, the strap 120, the mat 701, and the support body 722 may be stapled. The strap 120, the mat 701, and the support body 722 may be arranged such that the strap 120 is disposed between the mat 701 and the support body 722, the mat 701 is disposed between the strap 120 and the support body 722, or the support body 722 is disposed between the strap 120 and the mat 701. The strap 120 may be attached to the marking sheet 710. For example, the marking sheet 710 may be further included, for example, as disposed between the any of the strap 120, the mat 701, and the support body 722 and may be sewn, glued, or otherwise attached to the strap 120, the mat 701, and/or the support body 722 similarly to as described herein.

The strap 120 may be made of ribbon, but other materials are also suitable. For example, the strap 120 may be made of ribbon, fabric, chain, plastic, nylon, rope, canvas, cord, leather, suede, felt, or the like. The strap 120 may be attached near the first and second side edges 116, 118, respectively, near the first edge 112 of the mat 701. The strap 120 may be attached to the mat 701 near the first edge 112 of the mat 701, and the first edge 112 of the mat 701 may be attached to the support body 722. However, aspects need not be limited thereto; for example, the strap 120 may be attached to a portion of the support body 722 opposite from a portion on which or at which at least one of the mat 701 and the marking sheet 710 is attached to the support body 722. For example, ends of the strap 120 may be attached to ends of the support body 722, respectively, or at least one of the ends of the strap 120 may be attached to a side surface of the support body 722 about which the mat 701 is disposed when the design mat and wall 700 is disposed in the closed position similar to as shown in FIGS. 3 and 6. Moreover, the support body 722 could be hollow with open ends, and at least one end of the strap may be attached to an internal surface of the support body 722. The strap 120 may be attached to the support body 722 at a portion of the support body 722 opposite from a portion of the support body 722 to which the mat 701 and/or the marking sheet 710 is attached, i.e., the strap 120 and the mat 701 and/or the marking sheet 710 may be attached to opposite sides of the support body 722. However, aspects need not be limited thereto; for example, the strap 120 and the mat 701 and the marking sheet 710 may be attached to the support body 722 at a same portion of the support body 722, may be attached adjacently to the support body 722, or may be attached to a side or portion of the support body 722, for example, a quarter of the way around the support body 722. The strap 120 may be foldable to be disposed between the mat 701 and/or the marking sheet 710 and the support body 722 when the design mat and wall 700 is disposed in the closed position similar to as shown in FIGS. 3 and 6. The foldability of the strap 120 provides for the design mat and wall 700 to be easily disposed in the closed position similar to as shown in FIGS. 3 and 6. Specifically, the foldability of the strap 120 allows for the mat 701 and the marking sheet 710 to be rolled or wrapped around the strap 120 and the support body 722 instead of between the strap 120 and the support body 722. Further, the strap 120 may include a fastener to secure the strap 120 to the mat 701 and/or the support body 722 when the design mat and wall 700 is disposed in the closed position similar to as shown in FIGS. 3 and 6.

The design mat and wall 700 includes the marking sheet 710. The marking sheet 710 may be a clear acrylic, vinyl, or plastic sheet. The marking sheet 710 may be made of any clear material that has an erasable surface, but other materials are also suitable. The marking sheet 710 may be placed on or over the design surface 110 of the mat 701 with first edge 112 of the mat 701 and the first edge 712 of the marking sheet 710 being aligned or flush together or placed close together in a parallel fashion, for example, ½ inch or more apart.

The first edge 112 of the mat 701 and the first edge 712 of the marking sheet 710 may be attached to the support body 722 with the marking sheet 710 adjacent to the outside of the support body 722 and the back surface 210 of the mat 701 positioned towards the outside of the design mat and wall 700 when disposed in the closed position similar to as shown in FIGS. 3 and 6.

As shown in FIG. 8, the mat 701 and the marking sheet 710 may be attached to the support body 722. The support body 722 may be made of polyvinyl chloride (PVC) pipe, but other materials are also suitable. For example, the support body 722 may be made from a polymer, a plastic, a metal, wood, or the like. A length of the support body 722 may be at least 12 inches long, but other lengths are also suitable. For example, the length of the support body 722 along a long axis of the support body 722 may be 2 feet or 3 feet or longer, or may be fewer than 12 inches long, for example, 6, 8, 10, 11 inches, or the like. The support body 722 may be a minimum diameter of at least 1 inch, but other diameters are also suitable. For example, the support body 722 may have a cylinder shape with a diameter of 2, 3, 5, or more inches. The diameter may be an internal diameter or an external diameter. However, aspects of the present invention need not be limited thereto such that the support body 722 may have a hollow polygonal prism shape of similar dimensions, for example, a triangular prism shape, a square or rectangular prism shape, a pentagonal prism shape, or the like. The mat 701 and the marking sheet 710 may be attached to the support body 722 with staples and an air compressor, but other materials are also suitable. For example, the mat 701 and/or the marking sheet 710 may be attached to the support body 722 by staples, glue, nails, hook and loop, snaps, grommets, ties, ribbon, fabric, adhesive, rivets, buttons, or the like.

The second edge 114 of the mat 701 may be reinforced with a support strip 413 and/or a batten 410. For example, the support strip 413 may be a portion of the second edge 114 of the mat 701 folded towards the design surface 110 and toward the first edge 112 and support body 722 such that the back surface 210 of the mat 701 is exposed. The second edge 114 of the mat 701 may be sewn to the design surface 110 to form the support strip 413. The support strip 413 may also be sewn along the first and second side edges 116, 118. Further, the batten 410 may be inserted into the support strip 413 before or after the second edge 114 is sewn and/or before or after at least one of the first and second side edges 116, 118 is sewn. However, aspects need not be limited thereto such that the batten 410 may be adhered and/or attached to the mat 401 separately from and without the support strip 413. The batten 410 may be made of a metal, wood, or plastic, for example, a curved metal surface similar to a measuring tape or slap bracelet shape, but other materials are also suitable. For example, the batten 410 may be made of cardboard or upholstery tape. The batten 410 stabilizes the second edge 114 of the mat 701 and prevents quilt pieces from slipping out of the design mat and wall 700.

A loop 412 is attached to the second edge 114 of the mat 701. The loop 412 be made of a fabric, plastic, canvas, leather, suede, felt, or the like, and other materials are also suitable. The loop 412 may be inserted or attached to the mat 701 before sewing the second edge 114 to form the support strip 413 so that the loop 412 may be secured to the mat 701 by the support strip 413. The loop 412 may be used to securely hold accessories in the mat 701 when the design mat and wall 700 is disposed in the closed position similar to as shown in FIGS. 3 and 6.

Hook and loop or cooperable fasteners 124 are attached to the design surface 110 and the back surface 210 of the mat 701 along the first and second side edges 116, 118, respectively, of the mat 701 near the second edge 114 of the mat 701. The fasteners 124 may be hook and loop, buttons, reusable adhesives, snaps, grommets, ties, ribbon, or fabric or any other suitable fastener. The fasteners 124 disposed on the design surface 110 of the mat 701 are disposed adjacent to the second edge 114 of the mat 701 and adjacent to the first and second side edges 116, 118, respectively, of the mat 701. The fasteners 124 disposed on the back surface 210 of the mat 701 are disposed adjacent to the first and second side edges 116, 118, respectively, of the mat 701 but are spaced from the second edge 114 of the mat 701 so as to accommodate the thickness of the mat 701, the marking sheet 710, a diameter or thickness of the support body 722, and various thicknesses of the fabric pieces that will be disposed and stored on the design surface 110 when the mat 701 is rolled, folded, or disposed about the support body 722 in the closed position similar to as shown in FIGS. 3 and 6. For example, centers of the fasteners 124 may be spaced apart by a distance between about equal to a circumferential length of the support body 722 to about four times the circumferential length of the support body 722. The fasteners 124 disposed on the design surface 110 of the mat 701 appropriately correspond to the fasteners 124 disposed on the back surface 210 so as to secure the design mat and wall 700 in the closed position similar to as shown in FIGS. 3 and 6. For example, centers of the fasteners 124 may be spaced apart by 6 to 10 inches but aspects need not be limited thereto, for example, the fasteners may be spaced apart by 10 or more inches. Further, although the fasteners 124 are shown in FIGS. 7 to 9 as being disposed in a direction parallel to the first and second side edges 116, 118, aspects need not be limited thereto such that one or more fasteners 124 may be disposed on the design surface 110 along the second edge 114 of the mat 701 and one or more fasteners 124 may be disposed on the back surface 210 to correspond to the one or more fasteners 124 disposed on the design surface 110 when the design mat and wall 700 is disposed in the closed position similar to as shown in FIGS. 3 and 6.

The design mat and wall 700 may further include end caps 414 disposable to close ends of the support body 722. The end caps 414 may be eliminated from, attached permanently to, or attached removably to the support body 722. The end caps 414 are attachable to each end of the support body 722 to create a storage container for accessories, for example, sewing supplies, such as thread, needles, pins, or the like, to be storable in the hollow support body 722. The end caps 414 may be solid or have one or more holes or slots extending therethrough. The end caps 414 be made of tapered rubber stoppers with center holes, but other materials are also suitable. For example, the end caps 414 may be made of rubber, silicone, wood, plastic, acrylic, cork, or the like. The end caps 414 may be secured in the ends of the support body 722 by friction, reusable adhesives, or the like. Further, the end caps 414 may include threads disposed about a surface of the end caps 414 threadable into complementary threads disposed on or in the ends of the support body 722. Moreover, the end caps 414 and the ends of the support body 722 may include complementary locking mechanisms such as pins and slots or a safety lock cap. The end caps 414 may be tapered, inset, or attached over the end of the support body 722 and/or the mat 701 and the marking sheet 710 wrapped around the support body 722. Further, the end caps 414 may include, incorporate, or be pincushions to hold pins and the like disposed therein.

FIG. 8 shows a perspective view of the design mat and wall 700 as it would be used on a horizontal surface. A perspective view of the design mat and wall 700 in a hanging or vertical position is shown in FIG. 9.

In use, the quilt maker will trace an existing design or draw a new design directly onto the marking sheet 710 using an erasable marking tool. Further, the quilt maker may place an existing design over or under the clear marking sheet 710 and tape or otherwise secure the design to the marking sheet 710 so as to eliminate the need to mark the marking sheet 710 while still having the design held securely in position over the design surface 110 of the mat 701. The marking sheet 710 is disposed on or over the design surface 110 of the mat 701 and is used for a guide to place the fabric pieces into their desired position according to the pattern drawn on the marking sheet 710. The quilt maker can flip the clear marking sheet 710 over the support body 722 to the back surface 210 of the design surface 110 to view the mock-up blocks from a distance to determine if any changes need to be made to the design. The marking sheet 710 may also be used to write a note for the quilter, for example, a number of blocks to make, dimensions of pieces to cut, or the color of fabric to use. Different colored marking tools may also be used to indicate a fabric placement.

A perspective view of the design mat and wall 700 disposed in a hanging position with the clear marking sheet 710 flipped over the support body 722 to the back surface of the mat 701 is shown in FIG. 9. The quilt maker can use the marking sheet 710 disposed on or over the design surface 110 of the mat 701 as a guide to reposition fabric pieces or substitute different colors of fabric pieces until the quilt maker is satisfied with the block. The marking sheet 710 will stay in position over the design surface 110 and will not need to be centered over the fabric pieces each time a piece is added or removed. The support body 722 is of sufficient diameter to accommodate basic sewing supplies like an erasable marking tool. The fabric pieces will not adhere to the smooth surface of the back surface 210 of the mat 701 or to the marking sheet 710. The fabric pieces will stay in place on the design surface 110 due to the nap of the design surface 110 of the mat 701. When the design that was drawn on the marking sheet 710 is no longer needed, the design may be removed and a new design drawn as desired.

The strap 120 allows the design mat and wall 700 to be hung vertically as a quilt design wall and used horizontally as a design mat. When rolled up, the strap 120 becomes a useful handle to carry the design mat and wall 700 like an umbrella as the strap 120 may be folded along the long axis of the support body 722 to extend beyond an end of the support body 722. The strap 120 of the design mat and wall 700 eliminates the need for additional mounting hardware when used in multiple locations. The quilt maker does not need any special tools or any additional time, expertise, or money to hang the design mat and wall 700. The quilt maker does not have to commit to having a design surface 110 in one location only. The design mat and wall 700 is a sturdy method to transport a quilt project from one location to the next. The design mat and wall 700 specifically addresses the unique needs of the quilt maker who appliqués. The marking sheet 710 is a convenient way to reference the pattern and check the placement of the fabric pieces. The clear marking sheet 710 may overlay the design surface 110 of the mat 701 in the same position each time, eliminating the need to center the pattern over the fabric pieces each time. Quilt makers will have all of the sewing tools that they need to work on their project ready to go. Sewing thread is easily stored, dispensed, and protected from unraveling. The storage space in the support body 722 is sufficient to accommodate multiple spools of thread that are necessary to work with multiple colors of fabric. The design mat and wall 700 is compact enough to store easily if the quilt maker needs to work on a different project and needs to quickly set the current project aside. The handle that is formed from the strap 120 can be slid over the quilt maker's arm or shoulder freeing both of the quilt maker's hands to hold other items during transit.

According to aspects of the present invention, the design mat and wall provides a design surface usable vertically as a design wall and horizontally as a design mat.

According to aspects of the present invention, the design mat and wall need not be disposed in a fixed location to hang the design wall, does not require any hardware to mount the design mat and wall in the vertical position, and the design mat and wall may be used in multiple locations.

According to aspects of the present invention, the design mat and wall includes a convenient handle for easy transport from one location to the next, the handle being formed from the strap and being slidable over the quilt maker's arm freeing both of the quilt maker's hands to hold other items during transit.

According to aspects of the present invention, the design mat and wall allows for compact storage of a quilt or craft project, provides storage for basic sewing supplies, like multiple spools of thread, needles, pins, thimble, scissors, seam ripper, and marking tools, and provides a thread dispenser to prevent thread from unraveling, rolling away, or getting dirty.

According to aspects of the present invention, the design mat and wall provides a marking sheet that is clear and erasable for repeated use and attached to the mat or the support body such that the sheet does not need to be centered over a design each time fabric pieces are added or removed.

According to aspects of the present invention, the design mat and wall provides a sturdy support body, which may be a cylinder or a polygonal prism, to allow for storage by rolling the mat effortlessly about the support body. According to aspects of the present invention, the design mat and wall provides a support strip and/or a batten to support an edge of the mat to keep fabric pieces from getting misplaced during transit, and the design mat and wall may be available in numerous colors.

Aspects of the present invention provide a portable design mat and wall provides a versatile, portable quilting device for quilt makers of various types of quilts and other craft constructions, such as embroidery.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired so long as they do not substantially destroy their intended purpose. Components that are shown directly connected or contacting each other can have intermediate structures disposed between them unless specifically stated otherwise. The functions of one element can be performed by two, and vice versa unless specifically stated otherwise. The structures and functions of one embodiment can be adopted in another embodiment. It is not necessary for all advantages to be present in a particular embodiment at the same time. Every feature that is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A design mat and wall, comprising:
a support body having a long axis;
a mat attached to the support body and at least partially disposable about the support body; and
a strap attached to at least one of the support body and the mat, the strap being foldable in a direction parallel to the long axis of the support body.

2. The design mat and wall of claim 1, wherein the mat is disposable about the support body about the long axis of the support body.

3. The design mat and wall of claim 1, wherein the mat comprises a design surface having a texture to releasably engage quilt pieces disposed thereon and a back surface being smooth so as to not engage the quilt pieces.

4. The design mat and wall of claim 1, further comprising an end cap attachable to at least one end of the support body.

5. The design mat and wall of claim 4, wherein the end cap comprises at least one hole or slot extending therethrough.

6. The design mat and wall of claim 1, wherein the support body is a hollow cylinder having an inner diameter of at least one inch or polygonal prism having a width of at least one inch.

7. The design mat and wall of claim 1, wherein the mat comprises a first edge attached to the support body and a second edge opposite the first edge, wherein the second edge comprises a support strip and/or a batten to strengthen the second edge.

8. The design mat and wall of claim 7, further comprising a loop attached to the mat at or near the second edge.

9. The design mat and wall of claim 1, further comprising one or more marking sheets attached to at least one of the mat and the support body, the one or more marking sheets being attached such that quilt pieces are disposable between the one or more marking sheets and the mat.

10. The design mat and wall of claim 9, wherein the marking sheet is clear and comprises an erasable surface from which markings are erasable.

11. The design mat and wall of claim 1, further comprising fasteners attached to the mat to fasten a design surface of the mat to a back surface of the mat when the design mat and wall is disposed in a closed position.

12. The design mat and wall of claim 11, wherein at least one of the fasteners is disposed at an end of the mat, the end of the mat being opposite to another end of the mat attached to the support body.

13. The design mat and wall of claim 1, wherein the mat is disposed about the support body about the long axis of the support body to position the mat and wall in a closed position in which one surface of the mat is completely concealed.

14. The design mat and wall of claim 1, wherein the strap is foldable to form a handle that extends beyond an end of the support body.

15. The design mat and wall of claim 1, wherein the design mat and wall is disposable in a closed position in which the strap is folded in the direction parallel to the long axis and the mat is disposed about the strap and about the support body about the long axis of the support body.

16. A method for quilt design and display, the method comprising:
disposing a piece to be quilted onto a design surface of a mat, the mat comprising the design surface, a back surface opposite the design surface, a first edge attached to a support body;
folding a strap attached to at least one of the mat and the support body along a long axis of the support body;
disposing the mat on which the piece is disposed about the support body and folded strap; and
securing the mat in the closed position disposed about the support body.

17. The method of claim 16, further comprising:
disposing the mat in an open position in which the mat is not disposed about the support body.

18. The method of claim 17, further comprising:
hanging the mat in a vertical position by the strap from a support to display the piece disposed on the mat.

19. The method of claim 16, further comprising:
disposing a spool of thread in the support body.

20. The method of claim 19, further comprising:
threading at least a portion of the thread through an end cap of the support body.
